(19) United States
(12) Patent Application Publication
(10) Pub. No.: US 2017/0032385 A1
(43) Pub. Date: Feb. 2, 2017

(54) SERVICE PROVIDER/CUSTOMER INFORMATION TRACKING SYSTEMS AND METHODS

(71) Applicant: Quasar Blu, LLC, Atlanta, GA (US)

(72) Inventor: Mark Thomas, Atlanta, GA (US)

(21) Appl. No.: 14/813,902

(22) Filed: Jul. 30, 2015

(51) Int. Cl. G06Q 30/02; G06Q 50/12

(52) U.S. Cl. CPC G06Q 30/0201; G06Q 30/0202; G06Q 30/0281; G06Q 50/12

(57) ABSTRACT

Systems and methods, according to various embodiments, facilitate improved interaction between service providers and their customers by, in response to determining that a particular service provider is working at a particular location and that a customer is in the particular location: (1) displaying information regarding the customer to the service provider; and (2) displaying information regarding the service provider to the customer. The displayed information may include, for example, information regarding the customer's past tipping history (e.g., information regarding one or more past tips that the customer previously left for the service provider), the number of times that the service provider has served the customer in the past, the name of the customer and/or the service provider, a picture of the customer and/or service provider, and/or other suitable information. This may help to strengthen relationships between service providers and their customers, and encourage better service and improved tipping practices.

### BACKGROUND

Currently, relationships between restaurant service providers (e.g., bartenders, waiters, baristas, etc. . . . ) and their customers are handled on an informal basis. Service providers may or may not remember customers who they have served in the past, and they may or may not recall a particular customer's name, service preferences, or the frequency and nature of past interactions with the customer. Similarly, customers may not remember the names of (or other information regarding) service providers who have served them in the past. Accordingly, there is a need for improved systems and methods for aiding service providers and customers in retaining information about each other.

### SUMMARY OF THE VARIOUS EMBODIMENTS

A computer-readable medium, according to various embodiments, stores computer-executable instructions for: (1) receiving an indication that a particular service provider is working at a particular location; (2) receiving an indication that a particular customer of the service provider is at the particular location; and (3) at least partially in response to receiving the indication that the particular customer is at the particular location, facilitating a display of information regarding the customer on a display screen of a computing device associated with the service provider.

A computer system for facilitating interaction between a particular service provider and a customer, according to various embodiments, comprises at least one processor and memory, and the computer system is adapted for: (1) receiving, from a computing device associated with the particular service provider, a first indication that the particular service provider is at a particular location; (2) receiving a second indication that a particular customer is at the particular location; and (3) at least partially in response to receiving the first and second indications, facilitating a display of information regarding the service provider on a display of a computing device associated with the customer.

A computer-implemented method of facilitating interaction between a particular service provider and a customer, according to various embodiments, comprises: (1) using one or more computer processors to receive an indication that a particular service provider has been assigned to serve a particular customer who is currently in the same location as the particular service provider; and (2) at least partially in response to receiving the indication, facilitating, via one or more computer processors, a display on a display screen of a computing device associated with the particular service provider, of information comprising the customer's name and information regarding the customer's tipping history.

### BRIEF DESCRIPTION OF THE DRAWINGS

Various embodiments of service provider/customer information tracking systems and methods are described below. In the course of this description, reference will be made to the accompanying drawings, which are not necessarily drawn to scale and wherein:

FIG. 1 is a block diagram of a service provider/customer information tracking system in accordance with an embodiment of the present system including a service provider/customer information tracking server;

FIG. 2 is a block diagram of the service provider/customer information tracking server of FIG. 1;

FIG. 3 is a flowchart that generally illustrates various steps executed by a location determination module according to a particular embodiment;

FIG. 4 is a flowchart that generally illustrates various steps executed by a service provider/customer information tracking module according to a particular embodiment;

FIG. 5 is a flowchart that generally illustrates various steps executed by a payment module according to a particular embodiment; and

FIGS. 6-15 are exemplary screen displays of a system according to various embodiments.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In general, service provider/customer information tracking systems, according to various embodiments, are adapted to help service providers (e.g., restaurant service providers such as bartenders, baristas, and waiters) and the customers of these service providers retain and access information about each other. For example, the system may be adapted to allow each customer to use a software application on a suitable computing device (e.g., an “app” on their portable computing device) to set up a profile that includes information such as: (1) the individual's name; (2) one or more of the individual's favorite alcoholic and/or non-alcoholic beverages (e.g., mixed drinks); (3) one or more preferences that the individual has regarding the way that the individual's one or more favorite beverages (or other beverages) are prepared (e.g., with extra olives, with a certain number of pumps of flavoring, or “on the rocks, without salt”); (4) one or more of the individual's favorite food items (or other food items); (5) one or more preferences that the individual has regarding the way that the individual's one or more favorite food items (or other food items) are prepared (e.g., the individual likes their hamburgers prepared well-done, likes their salads served with Ranch dressing on the side, likes their French fries prepared extra crispy, etc. . . . ); (6) one or more of the individual's favorite personal services (e.g., a particular type of massage at a spa, or a particular nail service at a nail salon); (7) one or more preferences that the individual has regarding the one or more of the individual's favorite personal services (e.g., the individual prefers female masseuses or prefers a particular color of nail polish when they have a manicure); (8) the individual's birthday; (9) one or more of the individual's favorite sports teams; (10) the individual's marital status; (11) the names, ages, and genders of the individual's children; (12) the individual's default tip percentage (e.g., 15%, 18%, 20%, etc. . . . ) (which may be specified either generally, or by geographical location (e.g., a first percentage when the person is in a first particular country, such as Germany, and a second percentage when the person is in a second particular country, such as the United States)); and/or (13) any other suitable information regarding the individual. In various embodiments, the system may be adapted to receive a photo from the individual and to store the photo in association with the individual's profile.

In particular embodiments, the computer system may augment the individual's profile information with information that the system stores in memory regarding the individual's past behavior. For example, as discussed in greater detail below, the system may track the user's location and/or histories of payments (e.g., tips) to one or more establishments and/or particular service providers. The system may then (e.g., substantially continuously or on a periodic basis), update the individual's profile to include information such as, for example: (1) the number of times that the individual has visited a particular establishment (e.g., within a particular time period); (2) the number of times a particular service provider has provided service to the individual (e.g., within a particular time period); (3) the individual's tipping history; (4) the individual's purchase history; or (5) any other suitable information.

In cases where the system tracks and stores the individual's tipping history, the system may update the user's profile to include, for example: (1) the average percentage or dollar value tip that the individual left at any type of establishment, or at certain types of establishments; (2) the average percentage or dollar value tip that the individual left at a particular location; (3) the highest percentage or dollar value tip that the individual left at any type of establishment or at certain types of establishments; (4) the lowest percentage or dollar value tip that the individual left at any type of establishment or at certain types of establishments; (5) the highest percentage or dollar value tip that the individual left at a particular establishment; (6) the lowest percentage or dollar value tip that the individual left at a particular establishment; (7) the highest percentage or dollar value tip that the individual has left for a particular service provider (e.g., a particular waiter or bartender); and/or (8) the lowest percentage or dollar value tip that the individual left for a particular service provider.

In cases where the system tracks and stores the individual's purchase history (e.g., history of purchases that the individual has made using a payment service provided by the system, the system may update the individual's profile to include, for example: (1) particular drinks or food items purchased by the individual; (2) the average total bill that the individual incurred at a particular establishment, at a particular type of establishment (e.g., bars, restaurants), and/or all establishments; (3) the average total bill that the individual incurred when being served by a particular service provider (e.g., a particular waiter or bartender); (4) the average total bill that the individual incurred at a particular time of day; (5) the highest and/or lowest bill that the individual incurred at a particular establishment, at a particular type of establishment, or at any establishment; (6) the highest and/or lowest bill that the individual incurred while being served by a particular service provider; and/or (7) any combination of the above.

In particular embodiments, the system is adapted to generate and display a customized profile for each individual based at least in part on: (1) the location of the individual (e.g., the establishment that the individual is visiting at (or around) the time that the profile is generated or updated); and/or (2) the service provider who is providing services to the individual at (or around) the time that the profile is generated or updated. As a particular example, as discussed in greater detail below, the system may be adapted to determine a location of a particular individual and a service provider who is providing service to the customer. In response to determining that the individual is at a particular bar and being served by a particular bartender, the system may, for example, display a profile of the individual on the display screen of a computing device associated with the particular bartender that indicates, for example: (1) the number of times the particular bartender has served the individual in the past; (2) the specific mixed drinks that the bartender has prepared for the individual in the past; (3) the average percentage or dollar value tip (e.g., per order and/or per drink) that the individual left for the bartender in the past; (4) the highest dollar value or percentage tip that the individual left for the bartender in the past; (5) the average percentage or dollar value tip (e.g., per order and/or per drink) that the individual has left at the establishment in the past; and/or (6) the highest dollar value or percentage tip that the individual left at the establishment in the past.

By providing this type of detailed information, the system may, for example, encourage individuals to tip more generously for good service since they will essentially get ongoing “credit” in the minds of the service providers for past generous tips. This may encourage the service providers to provide even better, more personal service, which may help to elevate the overall quality of service at the particular establishment. The system may also discourage low tipping, and promote closer customer/service provider relationships by providing information that may be helpful in helping service providers serve their customers in more customized and personal ways. The system may also help to establish a rapport between a customer and a service provider that would ordinarily not exist because the service provider has never provided a service to the customer. For example, if a customer visits a new bar, the service provider may be able to determine that, even though the service provider has not yet benefited from the customer's generous tipping practices, the customer is a good tipper from the customer's tipping history.

In various embodiments, the system allows service providers to use beacon technology (or other suitable technologies) to track the current presence of customers and to see the profiles of customers who are present.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of Internet-implemented computer software. Any suitable computer-readable storage medium may be utilized including, for example, hard disks, thumb drives, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any suitable type of network, including but not limited to: (1) a local area network (LAN); (2) a wide area network (WAN); and/or (3) a cellular network. It should be understood that a particular computer's connection to the network may be made via an external computer (for example, by connecting to the internet via a “hotspot” provided by a portable wireless device).

The computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

Example System Architecture

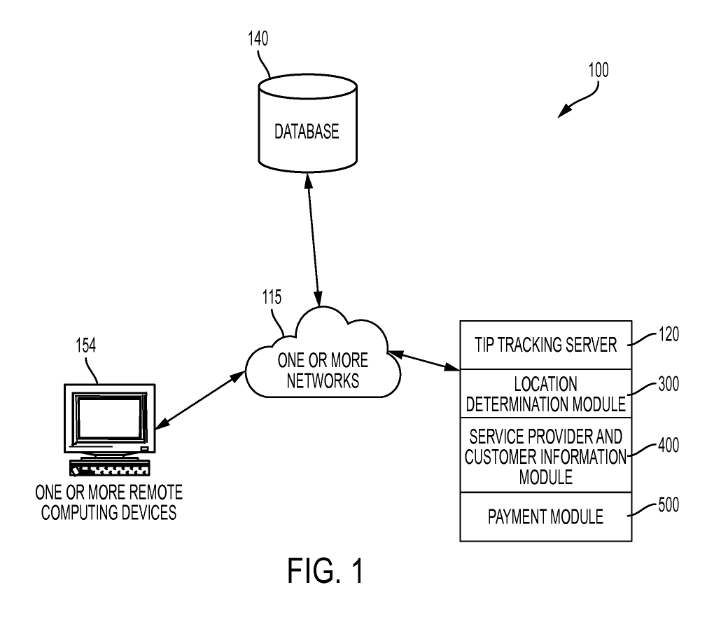

FIG. 1 is a block diagram of a service provider/customer information tracking system 100 according to particular embodiments. As may be understood from this figure, the service provider/customer information tracking system 100 includes one or more networks 115, a service provider/customer information tracking server 120 that may, for example, be adapted to execute a location determination module 300, a service provider/customer information tracking module 400, and a payment module 500, a database 140, one or more remote computing devices 154 (e.g., a smart phone, a tablet computer, a wearable computing device, a laptop computer, a desktop computer, etc.). In particular embodiments, the one or more computer networks 115 facilitate communication between the service provider/customer information tracking server 120, the database 140, and the one or more remote computing devices 154.

The one or more networks 115 may include any of a variety of types of wired or wireless computer networks such as the Internet (or other WAN), a private intranet, a mesh network, a public switch telephone network (PSTN), or any other type of network (e.g., a network that uses Bluetooth (standard or low energy Bluetooth), beacon communication technologies (e.g., iBeacon), and/or near field communications to facilitate communication between computing devices). The communication link (between the one or more remote computing devices 154 and the service provider/customer information tracking server 120 may be, for example, implemented via a Local Area Network (LAN) or via the Internet (or other WAN).

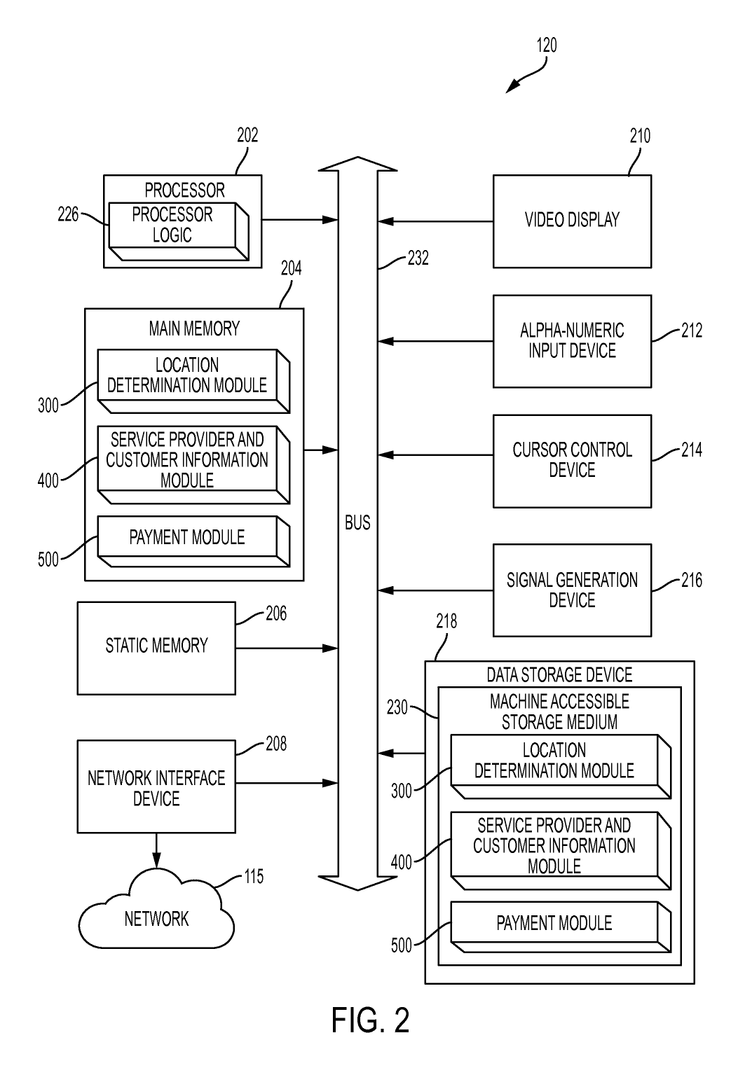

FIG. 2 illustrates an exemplary diagrammatic representation of the architecture of a service provider/customer information tracking server 120 that may be used within the service provider/customer information tracking system 100. It should be understood that the computer architecture shown in FIG. 2 may also represent the computer architecture of any one of the one or more remote computing devices 154 shown in FIG. 1. In particular embodiments, the service provider/customer information tracking server 120 may be suitable for use as a computer within the context of the service provider/customer information tracking system 100 that is configured for facilitating interaction between one or more service providers and one or more customers.

In particular embodiments, the service provider/customer information tracking server 120 may be connected (e.g., networked) to other computing devices in a LAN, an intranet, an extranet, and/or the Internet as shown in FIG. 1. As noted above, the service provider/customer information tracking server 120 may operate in the capacity of a server or a client computing device in a client-server network environment, or as a peer computing device in a peer-to-peer (or distributed) network environment. The service provider/customer information tracking server 120 may be a desktop personal computing device (PC), a tablet PC, a set-top box (STB), a Personal Digital Assistant (PDA), a cellular telephone, a web appliance, a network router, a switch or bridge, or any other computing device capable of executing a set of instructions (sequential or otherwise) that specify actions to be taken by that computing device. Further, while only a single computing device is illustrated, the single term “computing device” (or other such singular terminology referring to a computing device) should also be interpreted to include any collection of computing devices that individually or jointly execute a set (or multiple sets) of instructions to perform any one or more of the methodologies discussed herein.

As shown in FIG. 2, an exemplary service provider/customer information tracking server 120 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other and other system components via a bus 232.

The processor 202 represents one or more general-purpose or specific processing devices such as a microprocessor, a central processing unit (CPU), or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processor 202 may be configured to execute processing logic 226 for performing various operations and steps discussed herein.

The service provider/customer information tracking server 120 may further include a network interface device 208. The service provider/customer information tracking server 120 may also include a video display unit 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

The data storage device 218 may include a non-transitory computing device-accessible storage medium 230 (also known as a non-transitory computing device-readable storage medium or a non-transitory computer-readable medium) on which is stored one or more sets of instructions (e.g., the location determination module 300, the service provider/customer information tracking module 400, and the payment module 500) embodying any one or more of the methodologies or functions described herein. The location determination module 300, the service provider/customer information tracking module 400, and the payment module 500 may also reside, completely or at least partially, within the main memory 204 and/or within the processor 202 during execution thereof by the service provider/customer information tracking server 120—the main memory 204 and the processing device 202 also constituting computing device-accessible storage media. The location determination module 300, the service provider/customer information tracking module 400, and the payment module 500 may further be transmitted or received over a network 115 via a network interface device 208.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The terms “computing device-accessible storage medium” or “computer-readable medium” should also be understood to include any medium that is capable of storing, encoding, or carrying a set of instructions for execution by the computing device and that causes the computing device to include any one or more of the methodologies of the present invention. The terms “computing device-accessible storage medium” and “computer-readable medium” should accordingly be understood to include, but not be limited to, solid-state memories, optical and magnetic media, etc.

### Operation of Exemplary System

As noted above, a service provider/customer information tracking system 100, according to various embodiments, is adapted to facilitate communication between bartenders and other service providers and their customers. Various aspects of the system's functionality may be executed by certain system modules, including a location determination module 300, a service provider/customer information tracking module 400, and a payment module 500. The location determination module 300, the service provider/customer information tracking module 400, and the payment module 500 are discussed in greater detail below.

Location Determination Module

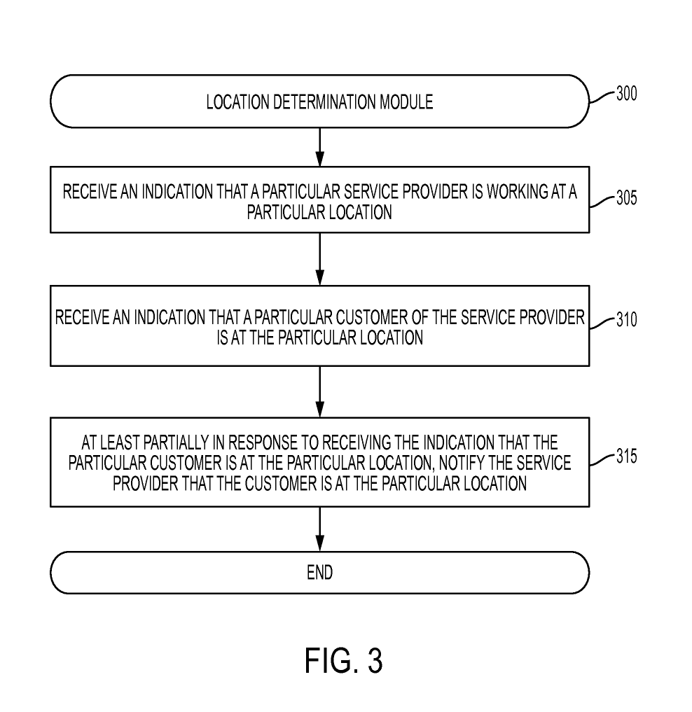

FIG. 3 shows a flow chart of operations performed by an exemplary location determination module 300, which may, for example, run on the service provider/customer information tracking server 120, or any suitable computing device (such as a suitable portable computing device). In particular embodiments, the location determination module 300 facilitates determining the respective locations of particular service providers and/or customers and/or determining when a particular service provider and a particular customer are both at a particular location.

The system begins, in various embodiments, at Step 305 by receiving an indication that a particular service provider is working at a particular location. In various embodiments, the particular location may include, for example, a particular establishment, such as a bar or restaurant. In some embodiments, the system may receive the indication that the particular service provider is working at the particular location by the service provider signing in to a particular application (e.g., an “app” running on their portable computing device). For example, the system may allow the user to sign in to the application and, once they are operating within the application, allow the user to turn on a “work mode” indicating that the service provider is currently working at the particular location.

In particular embodiments, the system may receive the indication that the particular service provider is working at the particular location by determining the GPS location of the particular service provider from a mobile device associated with the particular service provider. In various embodiments, the system may receive the indication that the particular service provider is working at the particular location using beacon technology (e.g., iBeacon). For example, the particular location may broadcast a unique identifier that the service provider's mobile computing device may receive when the service provider is in close proximity of (and/or at) the particular location and the system may receive this broadcast information and use the information to determine and/or confirm that the service provider is at the particular location.

In some embodiments, the system may receive the indication that the particular service provider is working at the particular location from a social media site, such as Facebook® (e.g., via an indication, from the social media site, that the particular service provider has “checked in” at the particular location and/or that a third party has indicated that the service provider is working at the particular location). According to various embodiments, the system may receive the indication that the particular service provider is working at the particular location from the particular service provider's work schedule (e.g., as received from the service provider's employer).

In various embodiments, the indication that the service provider is working at the particular location may include the time that the service provider began working at the particular location. In particular embodiments, the location that the service provider is working at may include any suitable establishment (e.g., a bar, restaurant, gym, department store, etc.). For example, the service provider may be working at a bar serving alcoholic beverages. In some embodiments, the service provider may be any suitable person who provides a service (e.g., bartender, barista, waiter, server, golf pro, masseuse, personal trainer, etc. . . . ). The work schedule may be a work schedule for a single establishment (e.g., a particular bar), or for multiple establishments or locations.

At Step 310, the system receives an indication that a particular customer is at the particular location. In various embodiments, the system receives an indication that the particular customer is at the particular location from a mobile computing device associated with the customer. In some embodiments, the system receives an indication that the particular customer is at the particular location using the GPS location and/or geolocation of a mobile computing device associated with the customer. In various embodiments, the system receives an indication that the particular customer is at the particular location when the customer is within a particular radius of the particular location. For example, the system may receive an indication that the customer is at the particular location when the customer is within a predetermined distance of the particular location. In particular embodiments, the system receives an indication that the particular customer is at the location by comparing the location of the mobile device associated with the customer with the location of the mobile device associated with the particular service provider. In some embodiments, the system receives an indication that the particular customer is at the particular location by the customer signing on to the application using a unique code provided by the particular location, or via suitable beacon technologies (e.g., as described above).

In various embodiments, the system receives an indication that the particular customer is at the particular location by the customer checking-in to the particular location on a social media site such as Facebook®. In some embodiments, the system may receive an indication that the particular customer is at the particular location by receiving an indication from a mobile device associated with the customer that the customer has used the particular location's “handle” on a social media site such as Twitter®. For example, the customer may create a tweet saying, “Best drink ever! @SottoSottoAtl” to indicate that the customer is at the particular location, Sotto, Sotto in Atlanta, Ga. In other embodiments, the system may receive an indication that the customer is at a particular location by another individual indicating that the customer is at the particular location (e.g., via a suitable social media site).

The system continues, at Step 315 by, at least partially in response to determining that the particular customer and the service provider are at the same location, notifying the service provider that the customer is at the particular location. In particular embodiments, the system may, at least partially in response to determining that the customer and the service provider are in the same location and that the service provider is currently working, notify the service provider that the customer is at the particular location. In various embodiments, the system may notify the service provider that the customer is at the particular location substantially automatically (e.g., automatically) in response to the system receiving an indication that the customer is at the particular location.

Similar to the system notifying the service provider that the customer is at the particular location, in various embodiments, the system may notify the customer that the particular service provider is currently working at the particular location. According to various embodiments, the system may notify the customer that the particular service provider is at the particular location substantially automatically (e.g., automatically) in response to receiving the indication that the particular service provider is working at the particular location. In some embodiments, the system may notify the customer that the particular service provider is working at the particular location in response to receiving an indication from the customer to notify the customer when that particular service provider is working at that particular location.

Service Provider and Customer Information Module

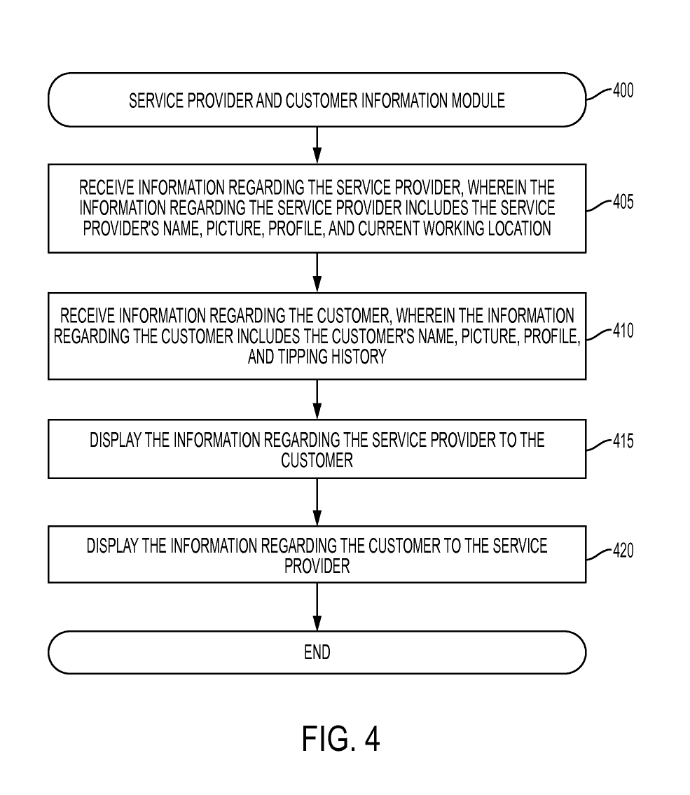

FIG. 4 shows a flow chart of operations performed by an exemplary service provider/customer information module 400, which may, for example, run on the service provider/customer information tracking server 120, or any suitable computing device (such as a suitable mobile computing device). In particular embodiments, the service provider/customer information module 400 stores and displays information regarding the customer and/or service provider. The system may display service provider information for a particular service provider, for example, when it notifies a customer that the particular service provider is working at the customer's current location (see discussion above). Similarly, the system may display customer information for a particular customer, for example, when the system notifies a particular service provider that the particular customer is at the service provider's current location.

In various embodiments, the system begins at Step 405 by receiving information regarding the service provider. In particular embodiments, the system receives information regarding the service provider from a profile set up by the service provider. In some embodiments, the profile set up by the service provider includes the service provider's name, picture, current working location, relationship status, work history, work schedule, etc. . . . . In various embodiments, the information regarding the service provider may include a specialty alcoholic beverage made by, and/or featured by, the particular service provider. The information regarding the service provider may also include additional information, such as the number of customers who have “liked” the service provider, one or more videos of the service provider providing service to individuals (e.g., preparing particular alcoholic beverages), or any other suitable information.

In some embodiments, the system may provide a particular customer with greater access to a particular service provider's profile information based, at least in part, on the tipping history of the particular customer. For example, the system may be adapted to provide access to exclusive content (e.g., exclusive videos, more detailed personal information, etc. . . . ) to customers who have tipped over a certain threshold amount, or who, on average, tip the particular service provider (or a particular establishment) over a certain percentage of the customer's total bill.

At Step 410, the system receives information regarding the customer, which may include information from a customer profile set up by the customer. In some embodiments, the profile may include, for example, the following information for the customer: (1) name; (2) picture; (3) relationship status; (4) birthday; (5) children's name(s), age(s), and gender(s); (6) favorite beverage(s); (7) one or more of the customer's preferences regarding how a particular beverage is prepared (e.g., with extra olives, on the rocks, with a sugar rim); (8) one or more favorite foods; (9) one or more preferences as to how a particular food item is prepared (e.g., steak cooked rare, salad with Ranch dressing on the side); (10) one or more favorite personal services (e.g., a particular type of massage, a particular nail service at a salon); (11) one or more preferences as to how a particular personal service is performed (e.g., light pressure for a massage, female masseuse); (12) one or more favorite sports teams; (13) the customer's default tip percentage (e.g., 15%, 18%, 20%); and/or (14) any other suitable information regarding the customer. In particular embodiments, the default tip percentage may be specified generally or specified for a particular country. For example, the customer may specify the default tip in Germany to be 10% and the default tip in the United States to be 20%. In various embodiments, the information regarding the customer may include any other suitable information about the customer (e.g., comments, connections, social network accounts, hometown, etc.).

In particular embodiments, the system may receive the information regarding the customer by, for example, tracking the location and activity (e.g., spending and/or tipping activity) of the customer. For example, the system may track the customer's payment history at one or more particular establishments including one or more tips that the customer has left at those establishments. In some embodiments, the information that the system receives by tracking the customer's activity may include, for example: (1) the number of times that the customer has visited a particular establishment (e.g., within a particular time period); (2) the number of times a particular service provider has provided service to the customer (e.g., within a particular time period); (3) the customer's tipping history; (4) the customer's purchase history; or (5) any other suitable information. In some embodiments, the system may store the received information regarding the customer in memory. In particular embodiments, the system may use the stored information to populate one or more fields within the customer's profile. In various embodiments, the system may populate fields in the customer's profile substantially automatically, substantially continuously, on a periodic basis, and/or after receiving an indication from the customer that the system should populate fields in the customer's profile with information that the system has tracked and stored.

As noted above, the system may, in some embodiments, track and store the customer's tipping history. The customer's tipping history may include, for example, for each individual purchase by a customer (e.g., at specified establishments or specified types of establishments), the amount of each tip left by the customer, the total amount of the corresponding bill, a list of the items purchased by the customer, and an indication of when the purchase was made.

In some of these embodiments, the system may provide information correlating to the time of day that the customer leaves tips and the amount of the tip. For example, the system may display a graph indicating that the customer tends to leave higher tips later in the evening. In various embodiments, the tipping history may include: (1) the average percentage or dollar value tip that the individual (e.g., the customer) left at any type of establishment, or at certain types of establishments; (2) the average percentage or dollar value tip that the individual left at a particular location; (3) the highest percentage or dollar value tip that the individual left at any type of establishment or at certain types of establishments; (4) the lowest percentage or dollar value tip that the individual left at any type of establishment or at certain types of establishments; (5) the highest percentage or dollar value tip that the individual left at a particular establishment; (6) the lowest percentage or dollar value tip that the individual left at a particular establishment; (7) the highest percentage or dollar value tip that the individual has left for a particular service provider (e.g., a particular waiter or bartender); and/or (8) the lowest percentage or dollar value tip that the individual left for a particular service provider.

In various embodiments, the tipping history may provide other data regarding the customer's typical tipping behavior. For example, the tipping history may indicate an average tip that the customer leaves per drink (e.g., alcoholic or coffee drink) ordered. In some embodiments, the tipping history of the customer may include one or more out-of-the-ordinary tips that the particular customer has left for a particular service provider in the past. For example, the tipping history may indicate that the customer left a particular service provider a $20 tip on a $5 total bill on a particular date.

In particular embodiments, the system may also track and store the customer's purchase history. This information may include, for example: (1) particular drinks or food items purchased by the individual (e.g., the customer); (2) the average total bill that the individual incurred at a particular establishment, at a particular type of establishment (e.g., bars, restaurants), and/or all establishments; (3) the average total bill that the individual incurred when being served by a particular service provider (e.g., a particular waiter or bartender); (4) the average total bill that the individual incurred at a particular time of day; (5) the highest and/or lowest bill that the individual incurred at a particular establishment, at a particular type of establishment, or at any establishment; (6) the highest and/or lowest bill that the individual incurred while being served by a particular service provider; and/or (7) any combination of the above.

In some embodiments, the system may be configured to allow a customer to place limits on the one or more types of information that the system receives regarding the customer. For example, the customer may elect to have the system receive the customer's name and picture but not the customer's purchase history. In various embodiments, the limits placed on the one or more types of information that the system receives may include limits pertaining to time, location, particular service providers, etc. For example, the customer may elect for the system to receive information regarding the customer when the customer is at a particular location such as at a particular bar, but not at other establishments.

At Step 415, the system, according to various embodiments, displays the information regarding the service provider to the customer and at Step 420, the system displays the information regarding the customer to the service provider. In various embodiments, the system may generate and display a customized profile for the customer for a particular service provider to view. In particular embodiments, the system may generate and display a customized profile for the service provider for a particular customer to view. In some embodiments, the customized profile for the customer may be based at least in part on: (1) the location of the customer (e.g., the establishment that the customer is visiting at (or around) the time that the profile is generated or updated); and/or (2) the service provider who is providing services to the customer at (or around) the time that the profile is generated or updated.

In various embodiments, the customer's profile (as displayed to a particular service provider) may include, for example: (1) the customer's name; (2) the customer's picture; (3) the customer's tipping history; (4) the customer's purchase history; (5) the number of times that the particular service provider has served the customer in the past; (6) the specific items that the service provider prepared for the customer in the past; (7) the average percentage and/or dollar value tip that the customer left for the service provider in the past; (8) the highest and/or lowest percentage and/or dollar value tip that the customer left for the service provider in the past; and/or (9) the highest and/or lowest percentage and/or dollar value tip that the customer left at the establishment in the past.

In various embodiments, the displayed profile for the customer to view may include the service provider's full profile. In other embodiments, the displayed profile may include one or more excerpts from the service provider's full profile. In particular embodiments, the displayed profile may include one or more items of information regarding interactions that the customer has had with the service provider. For example, the displayed profile may include: (1) the service provider's name; (2) the service provider's picture; (3) the number of times that the particular service provider has served the customer in the past; (4) one or more pieces of information from the customer's tipping history with the particular service provider (e.g., the average, highest, and/or lowest tip that the customer has left for the particular service provider in the past; (5) one or more specific items that the service provider prepared for the customer in the past; (6) one or more ratings that the customer has left for the service provider in the past; and/or (7) any other suitable information.

The system may, for example, display the respective information in response to the system receiving an indication that the service provider: (1) is in close proximity (e.g., within a predetermined distance of) of the customer; (2) is at the same location (e.g., same establishment) as the customer; and/or (3) has been assigned to serve the customer.

In some embodiments, the system may display the respective information automatically to the respective party. In other embodiments, the system may display the respective information in response to receiving a request from the respective party to display the information. In various embodiments, the system may only display the service provider's information to the customer if the customer is “following” the service provider on one or more social media networks. In particular embodiments, the system may only display the service provider's information to the customer if the customer has previously tipped the particular service provider.

Payment Module

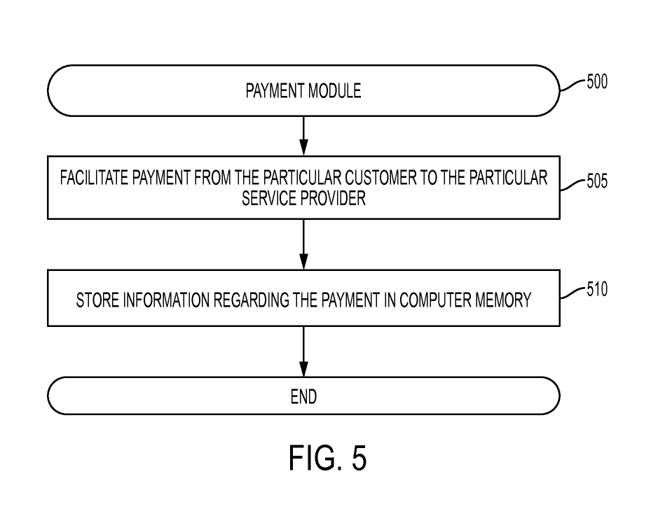

FIG. 5 shows a flow chart of operations performed by an exemplary payment module 500, which may, for example, run on the service provider/customer information tracking server 120, or any suitable computing device (such as a suitable mobile computing device). In particular embodiments, the payment module 500 facilitates payment for services provided by the particular service provider to the particular customer at a particular location (e.g., for payment of tips, a customer's bill, or both).

Beginning, in various embodiments, at Step 505, the system facilitates payment from the particular customer to the particular service provider. In various embodiments, the system receives an indication of a total bill from the service provider. At least partially in response to receiving the total bill from the service provider, in some embodiments, the system notifies the customer of the total bill and its related details. In particular embodiments, the system receives payment information from the customer. In various embodiments, the payment information may include credit card information, debit card information, bank account information, PayPal account information, etc. In particular embodiments, the payment information may include the total amount to be paid, including a tip for the particular service provider.

In particular embodiments, the system facilitates an electronic payment exchange between the customer and service provider. For example, the customer may enter their credit card information and the system may facilitate the relevant transfer of funds (in any suitable manner) to the service provider. In some embodiments, the system may save the customer's payment information for future purchases. In various embodiments, the system may require authorization for every payment. In some embodiments, the system may receive an indication of pre-authorization for every payment from the customer. For example, the customer may set up their account to automatically pay using a particular credit card without requiring the customer to re-enter the number of the credit card or other related information.

In addition to facilitating payment from the particular customer to the particular service provider, the system may also allow a customer to place an order for one or more items. For example, if the customer is not able to get the service provider's attention to place an order, or simply as a convenience to the customer, the customer may select to re-order a previous order placed with the particular service provider (e.g., another of the same drink) or may place a new order with the service provider.

At Step 510, the system stores information regarding the payment in computer memory. In various embodiments, the system stores the payment information substantially automatically (e.g., automatically) in response to receiving the payment information. This information may include, for example, payment, tipping, and purchase information, such as the information discussed in greater detail above. In some embodiments, in addition to storing the information regarding the payment, the system may facilitate communication between the service provider and the customer. For example, the service provider may wish to “thank” the customer for a tip by sending an electronic thank you note to the customer through the application.

### Exemplary User Experience

Profile for Service Providers

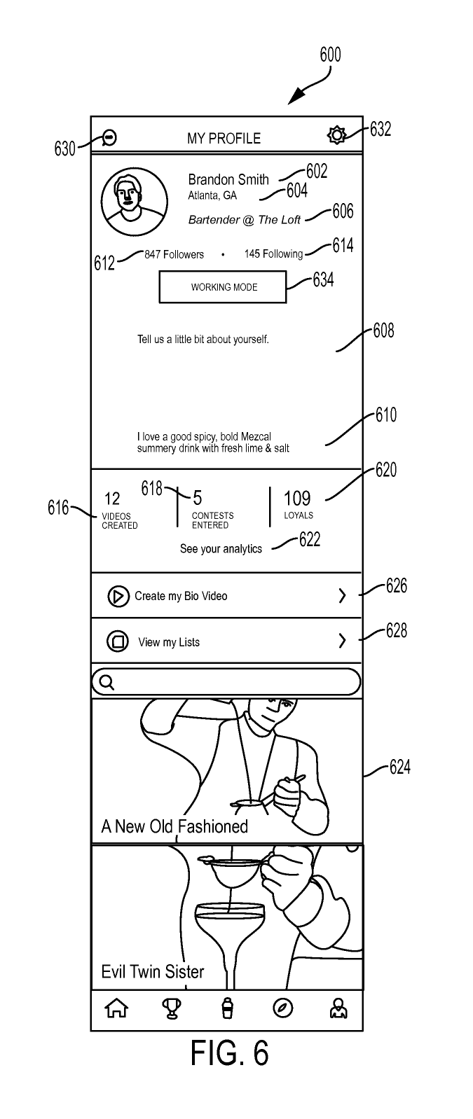

FIGS. 6-13 depict user interfaces that the system may display to a particular service provider using a suitable software application, such as those described above. The service provider may access the software application from the service provider's mobile computing device. As may be understood from FIG. 6, the software application allows a service provider to set up a profile page 600. The profile page 600 includes the service provider's name 602, hometown 604, and occupation 606. The profile page 600 also allows the service provider to enter information about the service provider such as a summary 608 and the service provider's favorite beverage 610. Similar to other social media networks, the profile page 600 may include a link to the followers 612 for the service provider and a link to those that the service provider is following 614. The profile page may also include videos created by the service provider 616, content entered 618, and the number of loyal customers 620 that particular service provider currently has. The profile page may also include a link to view service provider analytics 622 that the software application may have gathered, for example, using the techniques described above. On the profile page 600, the service provider may view videos 624 created by the service provider. The service provider may also create a biography video by selecting the “create my bio video” button 626, or view a list of one or more drinks or other items by selecting the “view my lists” button 628.

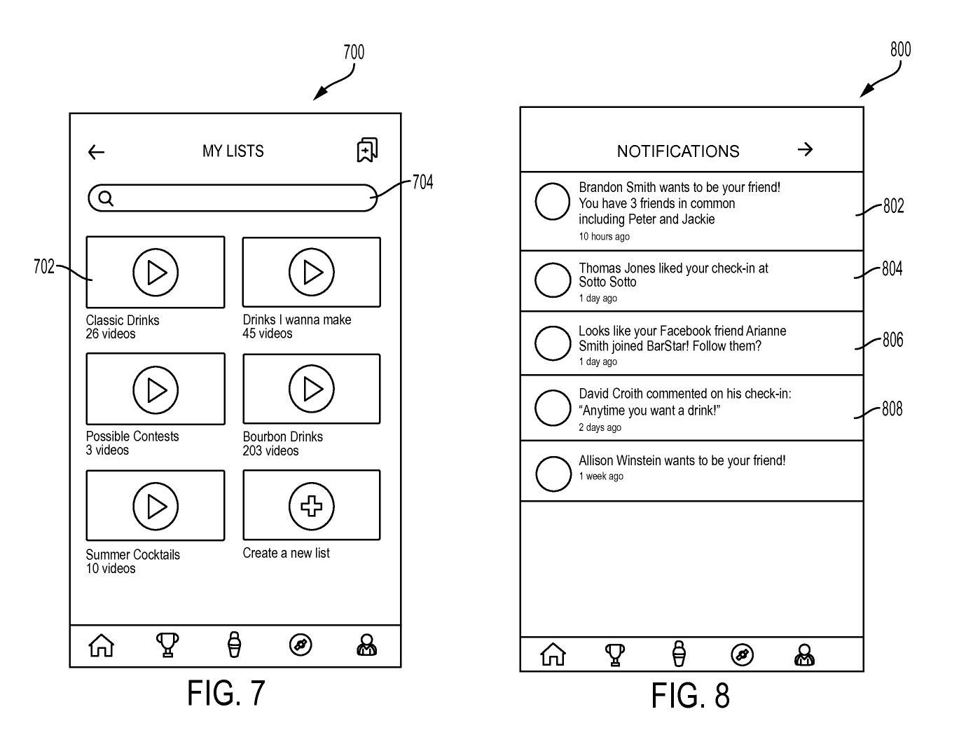

In response to the service provider selecting the “view my lists” button 628 from FIG. 6, the system directs the service provider to a lists page 700, as shown in FIG. 7. The lists page 700 may include a list of drinks, foods, services, and any other item that may be put into list form. The lists may include videos, pictures, and text relating to the particular items in the list. The lists may also be grouped by a particular topic. For instance, the service provider may create a list titled classic drinks 702 for drinks that the service provider considers classics. The lists page 700 may also include a search bar 704 for searching through the service provider's various lists.

Returning to FIG. 6, the profile page includes a notification button 630 that the service provider may select to view notifications sent to the service provider. In response to selecting the notification button 630, the service provider may be directed to the notification page 800, as shown in FIG. 8. The notification page 800 includes notifications sent to the service provider such as friend requests 802, likes 804, suggestions 806, and comments 808.

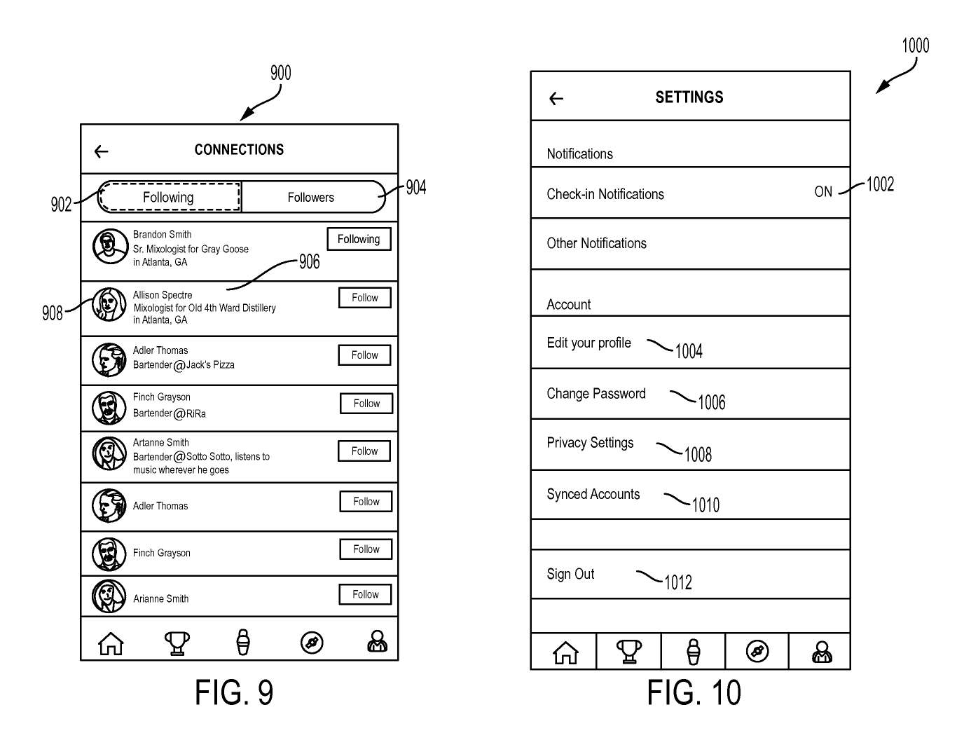

As shown in FIG. 6, the service provider may select either the “followers” link 612 or the “following” link 614 to be directed to the connections page 900, as shown in FIG. 9. The connections page 900 allows the service provider to view individuals that the service provider is following 902 and also individuals that are following the service provider 904. The connections page may include the name of the person 906 following or being followed as well as a picture of the person 908.

Returning again to FIG. 6, the profile page 600 includes a settings button 632 that allows the user to select various settings. In response to the service provider selecting the settings button 632, the system directs the service provider to the settings page 1000, as shown in FIG. 10. On the settings page 1000, the service provider is able to turn on and off notifications 1002, edit their profile 1004, change their password 1006, change their privacy settings 1008, sync various social media accounts 1010, and sign out 1012. In various embodiments, the settings page 1000 may include any suitable setting such as the following settings: volume, location, Wi-Fi, Bluetooth, sounds, etc.

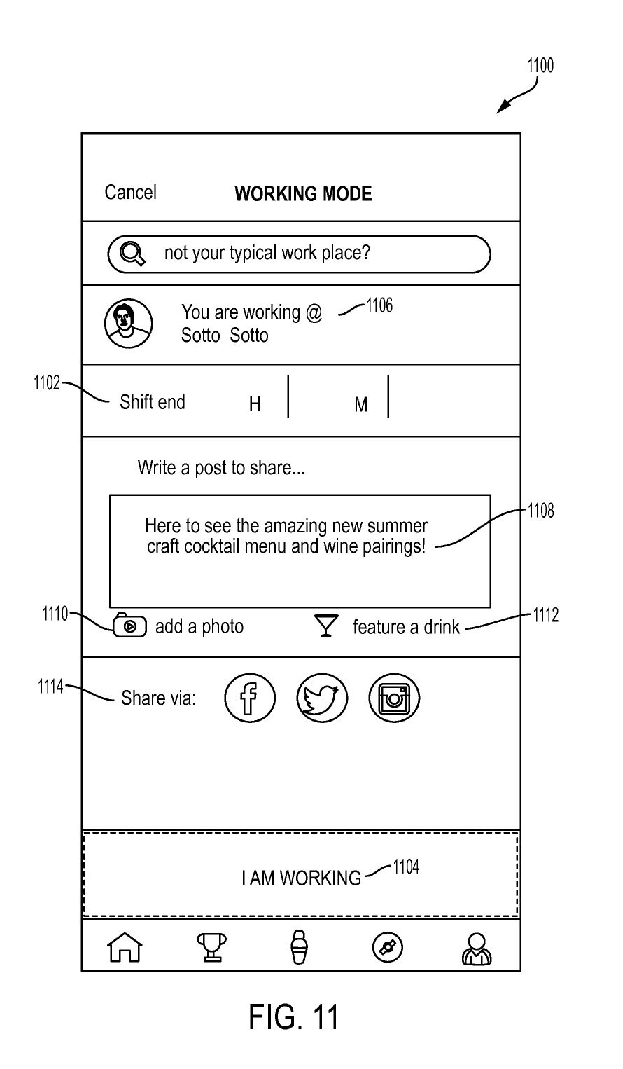

Referring again to FIG. 6, once the service provider is ready to begin working at a particular location, the service provider may select the “working mode” button 634 to be directed to the working mode page 1100, as shown in FIG. 11. While on the working mode page 1100, the service provider may begin or end a shift at a particular location. For example, the service provider may enter a shift end time into the shift end field 1102. The service provider may begin the shift by selecting the “I am working” button 1104. As indicated by the working mode page 1100, the current working location 1106 of the service provider is then displayed. The working mode page 1100 also allows the service provider to write a post to share over a social network in the post text box 1108. In addition to posting comments, the service provider may also select an “add a photo” button 1110 to add a photo. By selecting the feature a drink button 1112, the service provider is able to select a drink from an electronic beverage menu to feature for customers. The service provider is also given the option to share that the service provider is currently working through the various social network buttons 1114 on the working mode page 1100.

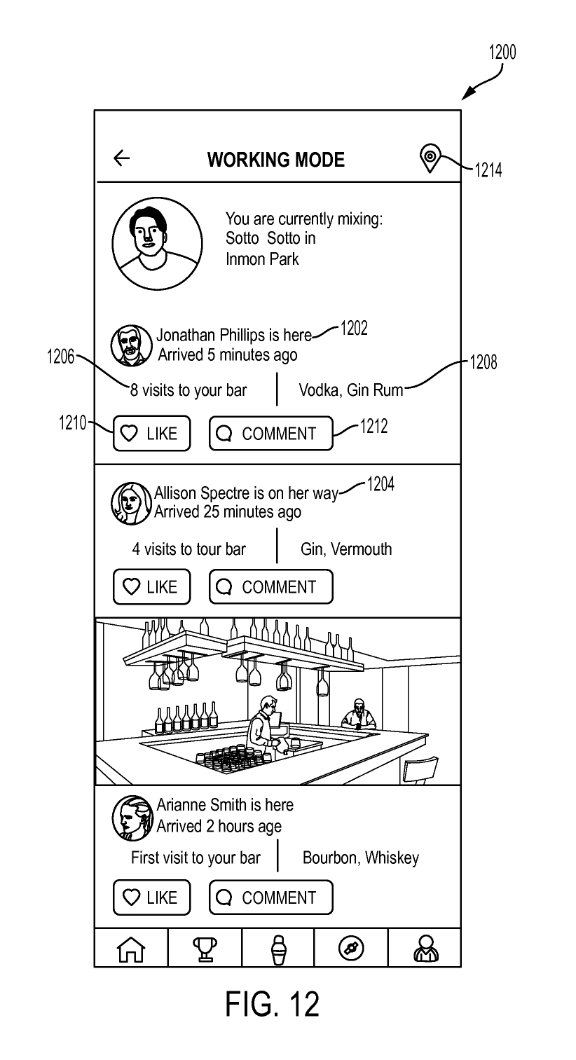

In response to the service provider selecting the “I am working” button 1104 of FIG. 11, the system advances the service provider to the location page 1200 of FIG. 12. While viewing the location page 1200, the service provider is able to see customers who are currently at the same location 1202 as the service provider and customers who are en route 1204 to the particular location. The service provider is also able to view each of the customer's number of visits to the particular location 1206 and also the customer's preferred alcoholic beverage 1208. For each customer, the service provider may “like” the customer using the like button 1210 and/or submit a comment to the particular customer using the comment button 1212. Using the location page 1200, the service provider may select the location button 1214 to turn on or off the locating feature of the application.

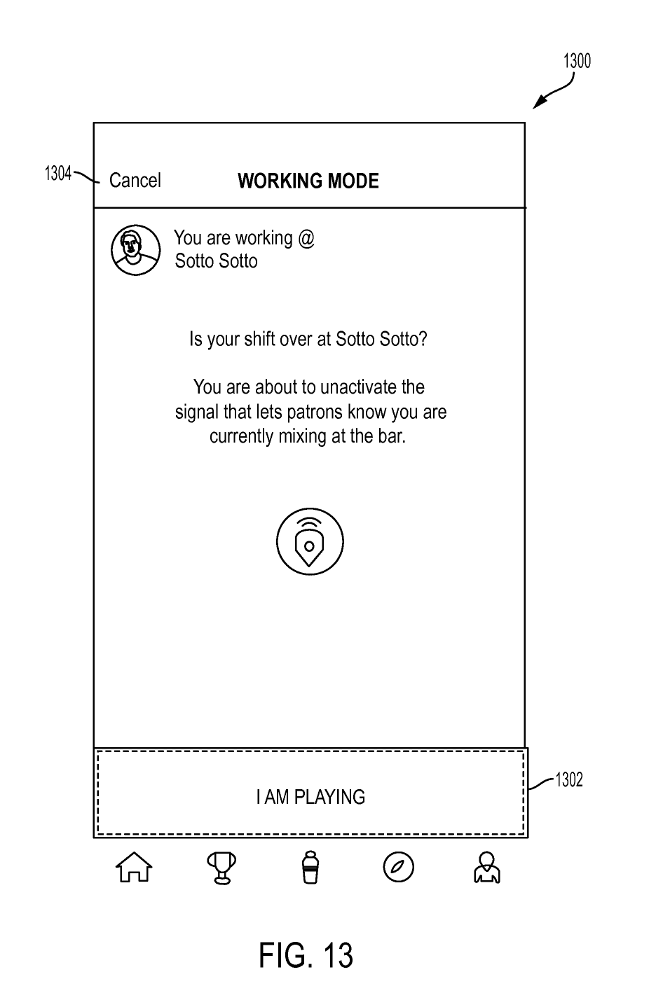

In response to the service provider selecting the location button 1214 of FIG. 12, the system directs the service provider to the end shift page 1300 of FIG. 13. If the service provider is ready to end his or her shift, the service provider may select the “I am playing” button 1302 to indicate that the service provider's shift is over and the service provider is no longer working. However, if the service provider accidentally selected the location button 1214 or does not want to end the shift, the service provider may select the cancel button 1304.

Leaving a Tip

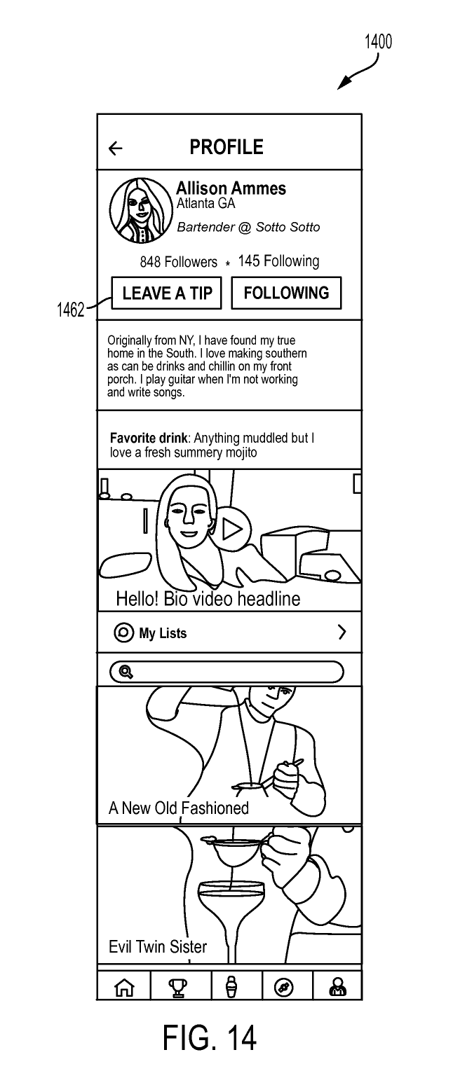

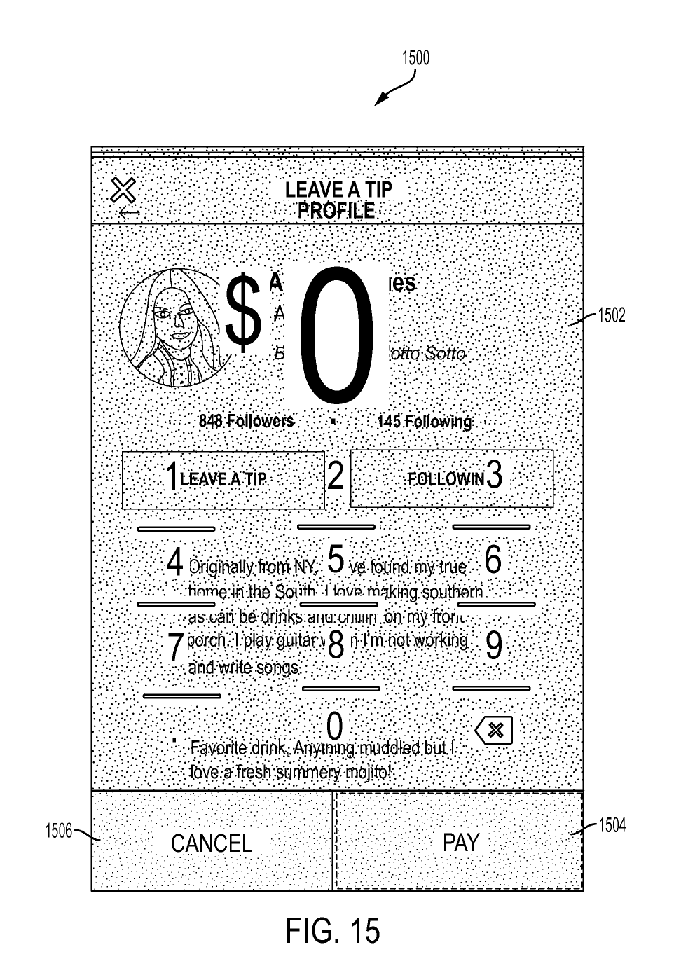

FIGS. 14 and 15 depict alternative user interfaces that are similar to the profile page 600 of FIGS. 6-13. Thus, for purposes of ease of understanding and clarity, only certain parts will be discussed to highlight the differences between the customer's user interfaces 1400, 1500 and the service provider's user interfaces shown in FIGS. 6-13.

As shown in FIG. 14, the customer's profile page 1400 resembles the service provider's profile page 600. Of importance, the customer's profile page 1400 shown in FIG. 14 includes a “leave a tip” button 1402 that enables the customer to leave a tip for a particular service provider.

In response to selecting the leave a tip button 1402 shown in FIG. 14, the customer is directed to the tip page 1500 where the customer may enter a tip amount 1502. The customer may also be directed to the tip page 1500 via a pop-up display initiated by a particular service provider requesting that the customer leave a tip. In various embodiments, the customer may include the name of the service provider, a comment about the service provider's services, a complaint about the service provider, etc. In some embodiments, the tip page 1500 may allow the customer to pay for the full bill from the particular service provider. In particular embodiments, the tip page 1500 may allow the customer to enter a coupon code and/or a promotion code. In response to entering the desired tip amount, the customer may select the pay button 1504 to confirm the payment of the tip. If the customer does not wish to leave a tip at that time, the customer may select the cancel button 1506 to return to the customer's profile page 1400.

Exemplary Bartender Experience

In a particular example of a service provider such as a bartender using the system, the bartender may log into the application on their mobile device at the beginning of their shift when, for example, six individuals are sitting at the bar. When the bartender logs in, the system indicates that four individuals who have an account with the software application are logged in to the application and are present at the bar. The system may display (e.g., on a single screen, such as the display screen of a tablet computer or smartphone associated with the bartender) the name of each of these four individuals, their profile picture, the number of times they visited the bar in the past, the number of drinks that they have purchased from the bartender, the total amount of money that they have spent in the bar over a predetermined period of time, their favorite drink, their tipping history (e.g., an average tip per drink ordered, or an average percent tip left on each bill), their hometown, their favorite sports team, their marital status, the names and ages of their family members, and/or any preferences that they have regarding their food or drinks (e.g., they like extra olives in their martinis). This may allow the bartender to quickly identify one or more individuals at the bar, and to better serve the individual based on the information provided by the system.

As the bar fills up, new individuals who have accounts with the application arrive at the bar and log into the application. As these new individuals arrive, they appear automatically on the bartender's display screen. Also, as logged-in individuals leave the bar, the system may automatically remove them from the bartender's display screen. This may help call the bartender's attention to individuals who have just arrived at the bar (and who will, therefore, need to be served a drink). It may also call the bartender's attention to individuals who have left (or are leaving) the bar so that the bartender can say goodbye to the individual, check the individual's area for lost items, etc. The system may also display an alert in response to individuals arriving or leaving.

Exemplary Customer Experience

In a particular example of a customer using the system, the customer may log into the software application on their mobile device before entering a bar. When the customer arrives at the bar, the system uses the GPS capabilities of the customer's mobile device to determine that the customer is currently at the bar. The system then automatically determines that a particular bartender is currently working at the bar and displays suitable personal information for the bartender (e.g., the bartender's name and picture), a listing of featured cocktails that the bartender is preparing that evening, one or more videos of the bartender preparing one or more of the featured cocktails, and/or any other suitable information from the bartender's profile, as discussed above. This information, may, for example, also include information regarding the past relationship between the customer and the bartender (e.g., information regarding one or more tips that the customer has left for the bartender in the past, past ratings that that customer has left for the bartender, the number of times that the bartender has served the customer, and any other suitable information). This may allow the customer to quickly identify the bartender, and to better interact with the bartender. As noted above, the software application may also facilitate the payment of a tip to the bartender, or the payment of the customer's entire bill.

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

I claim:

1. A computer-implemented method of facilitating the provision of service, by a particular bartender within a particular dining establishment, to a particular customer within the particular dining establishment, the method comprising:
providing a customer-information viewing application to the bartender for installation on a wireless bartender computing device associated with the bartender;
providing a dining-establishment-customer application to the customer for installation on a wireless customer computing device associated with the customer;
using at least one computing device comprising at least one processor and memory to:
receive an indication, from the dining-establishment-customer application, that the particular customer is in the particular dining establishment by comparing a first determined GPS location of the wireless customer computing device associated with the customer with a second determined GPS location of the wireless bartender computing device associated with the bartender;
at least partially in response to receiving the indication that the particular customer is in the particular dining establishment, transmitting an alert over one or more networks to the customer-information viewing application indicating that the particular customer is in the particular dining establishment, wherein the customer-information viewing application, in response to receiving the alert:
automatically causes a name of the particular customer to display on the display screen associated with the wireless bartender computing device;
automatically causes a picture of the particular customer to display on the display screen associated with the wireless bartender computing device so that the particular bartender may visually identify the particular customer; and
automatically causes information regarding one or more tips that the particular customer has left for the particular bartender in the past to display on the display screen associated with the bartender computing device.

2. (canceled)

3. The computer-implemented method of claim 1, wherein the information regarding the one or more tips comprises information regarding the largest tip that the particular customer has left for the particular bartender in the past.

4. The computer-implemented method of claim 1, wherein the information regarding the one or more tips comprises an average tip percentage that the particular customer has left for the particular bartender in the past.

5. The computer-implemented method of claim 1, wherein the customer-information viewing application, in response to receiving the alert, causes a number of times that the service provider has served the particular customer in the past to display on the display screen associated with the bartender computing device.

6. (canceled)

7. The computer-implemented method of claim 1, wherein the computer-implemented method further comprises using at least one computing device comprising at least one processor and memory to:
receive an indication, from the customer-information viewing application, that the particular bartender is in the particular dining establishment;
at least partially in response to receiving the indication that the particular bartender is in the particular dining establishment, transmitting an indication over one or more networks to the dining-establishment-customer application indicating that the particular bartender is in the particular dining establishment, wherein the dining-establishment-customer application, in response to receiving the indication:
causes a name of the particular bartender and a picture of the particular bartender to display on the display screen associated with the customer computing device.

8. The computer-implemented method of claim 7, wherein, the dining-establishment-customer application, in response to receiving the indication:
causes information regarding one or more tips that the particular customer has left for the particular service provider in the past to display on the display screen associated with the customer computing device.

9. (canceled)

10. The computer-implemented method of claim 8, wherein the information regarding the one or more tips comprises information regarding the largest tip that the particular customer has left for the particular bartender in the past.

11. The computer-implemented method of claim 8, wherein:
the dining-establishment-customer application facilitates one or more payments from the particular customer to the particular bartender; and
the computer-implemented method further comprises determining the information regarding one or more tips that the particular customer has left for the particular bartender in the past based, at least in part, on the information regarding the one or more payments.

12. The computer-implemented method of claim 11, wherein the one or more payments from the particular customer to the particular bartender comprises a tip.

13-16. (canceled)

17. The computer-implemented method of claim 1, wherein the customer-information viewing application, in response to receiving the alert, causes one or more service preferences of the customer to display on the display screen associated with the bartender computing device.

18. The computer-implemented method of claim 17, wherein the one or more service preferences comprise one or more service preferences selected from a group consisting of: a favorite item of the customer; and a preferred method of preparing a particular item for the customer.

19. A method of facilitating the provision of service, by a particular bartender within a particular dining establishment, to a particular customer within the particular dining establishment, the method comprising:
providing a bartender application to the bartender for installation on a wireless bartender computing device associated with the bartender;
providing a bartender-information viewing application to the customer for installation on a wireless customer computing device associated with the customer;
using at least one computing device comprising at least one processor and memory to:
receive an indication, from the bartender application, that the bartender is in the particular dining establishment by comparing a first determined GPS location of the wireless customer computing device associated with the customer with a second determined GPS location of the wireless bartender computing device associated with the bartender;
at least partially in response to receiving the indication that the bartender is in the particular dining establishment, transmitting an alert over one or more networks to the bartender-information viewing application indicating that the particular bartender is in the particular dining establishment, wherein the bartender-information viewing application, in response to receiving the alert:
automatically causes information regarding one or more tips that the particular customer has left for the particular bartender in the past to display on the display screen associated with the customer computing device.

20-21. (canceled)

22. The computer-implemented method of claim 19, wherein the information regarding one or more tips that the particular customer has left for the particular service provider in the past comprises the largest tip that the particular customer has left for the particular service provider in the past.

23. A method of facilitating the provision of service, by a particular server within a particular dining establishment, to a particular customer within the particular dining establishment, the method comprising:
providing a customer-information viewing application to the server for installation on a wireless server computing device associated with the server;
providing a dining-establishment-customer application to the customer for installation on a wireless customer computing device associated with the customer;
using at least one computing device comprising at least one processor and memory to:
receive an indication, from the dining-establishment-customer application, that the particular server has been assigned to serve the particular customer;
receive an indication, from the dining-establishment-customer application, that the customer is in the particular dining establishment by comparing a first determined GPS location of the wireless customer computing device associated with the customer with a second determined GPS location of the wireless server computing device associated with the server;
at least partially in response to receiving the indication that the customer is in the particular dining establishment and the particular server has been assigned to serve the particular customer, transmitting an alert over one or more networks to the customer-information viewing application indicating that the particular server has been assigned to serve the particular customer, wherein the customer-information viewing application, in response to receiving the alert:
causes a picture of the particular customer to display on the display screen associated with the wireless server computing device so that the particular server may visually identify the particular customer; and
causes information regarding one or more tips that the particular customer has left for the particular server in the past to display on the display screen associated with the wireless server computing device.

24. (canceled)

25. The computer-implemented method of claim 23, wherein the computer-implemented method further comprises using at least one computing device comprising at least one processor and memory to:
receive an indication, from the customer-information viewing application, that the particular bartender is in the particular dining establishment;
at least partially in response to receiving the indication that the particular bartender is in the particular dining establishment, transmitting an indication over one or more networks to the dining-establishment-customer application indicating that the particular bartender is in the particular dining establishment, wherein the dining-establishment-customer application, in response to receiving the indication:
causes a name of the particular bartender to display on the display screen associated with the customer computing device.

26. The computer-implemented method of claim 23, wherein:
the particular customer is a first particular customer;
the indication is a first indication;
the alert is a first alert and
the computer-implemented method further comprises:
using at least one computing device comprising at least one processor and memory to:
receive an indication, from the dining-establishment-customer application, that the particular server has been assigned to serve a second particular customer;
at least partially in response to receiving the indication that the particular server has been assigned to serve the second particular customer, transmitting a second alert over one or more networks to the customer-information viewing application indicating that the particular server has been assigned to serve the second particular customer, wherein the customer-information viewing application, in response to receiving the second alert:
while causing the picture of the first particular customer to display on the display screen associated with the wireless server computing service, causes a picture of the second particular customer to display on the display screen associated with the wireless server computing device so that the particular bartender may visually identify both the first particular customer and the second particular customer; and
while causing information regarding one or more tips that the first particular customer has left for the particular server in the past to display on the display screen associated with the wireless server computing device, causes information regarding one or more tips that the second particular customer has left for the particular server in the past to display on the display screen associated with the wireless server computing device.
